(19) United States
(12) Patent Application Publication
(10) Pub. No.: US 2013/0277447 A1
(43) Pub. Date: Oct. 24, 2013

(54) METHOD AND SYSTEM TO CONTROL A FUEL INJECTOR

(71) Applicants: Biju Nanukuttan, Bangalore (IN); Herbert Chidsey Roberts, III, Simpsonville, SC (US)

(72) Inventors: Biju Nanukuttan, Bangalore (IN); Herbert Chidsey Roberts, III, Simpsonville, SC (US)

(73) Assignee: GENERAL ELECTRIC COMPANY, Schenectady, NY (US)

(21) Appl. No.: 13/453,276

(22) Filed: Apr. 23, 2012

(51) Int. Cl. F02C 9/26; F02C 7/232

(52) U.S. Cl. 239/5; 239/412

(57) ABSTRACT

An injection system includes a plurality of actuators. Each of the actuators is configured to move one or more portions of a center body of the fuel injector. The system also includes a controller configured to control each of the plurality of actuators individually to change a flow rate or a direction of output of a mixture of fuel and air from an output of the center body of the fuel injector.

### BACKGROUND OF THE INVENTION

The subject matter disclosed herein relates to the control of a fuel injector.

In a fuel injection system, a fuel injector typically injects fuel at high pressure into a combustion engine where the fuel is mixed with air. In other injection systems, fuel and air are mixed and the mixture is injected. One example of such an injection system is late lean injection (LLI). The emissions of oxides of nitrogen, carbon monoxide, and unburned hydrocarbons in conventional gas turbine engines can be mitigated by the addition of an LLI system in a transition zone between the combustor and turbine. The LLI system can include a number of LLI injectors that inject a mixture of LLI fuel and LLI air into the transition zone.

Increased control over injectors is needed. In the case of an LLI system, for example, increased control over LLI injectors would result in increased mitigation of the unwanted emissions from combustion engines.

### BRIEF DESCRIPTION OF THE INVENTION

According to one aspect of the invention, a fuel injector control system includes a plurality of actuators, each actuator being configured to move one or more portions of a center body of the fuel injector; and a controller configured to control each of the plurality of actuators individually to change a flow rate or a direction of output of a mixture of fuel and air from an outlet of the center body of the fuel injector.

According to another aspect of the invention, an adjustable fuel injector includes a center body having a tube-like shape with an opening at an upper portion and at a lower portion that is at an opposite end from the upper portion along a length of the center body, the center body configured to mix fuel and air, the fuel and the air being input at the upper portion, and to funnel a mixture of the fuel and the air through an outlet at the lower portion; an outer body having a tube-like shape, the outer body encircling the center body and air being input between the outer body and the center body at the upper portion; and a plurality of actuators controlled by a controller, each of the plurality of actuators being configured to move a different portion of the center body.

According to yet another aspect of the invention, a method of controlling an output of an injector includes arranging a plurality of actuators to move different parts of a center body of the injector; and controlling movement of the plurality of actuators to change a size and a shape of an outlet of the center body of the injector.

### BRIEF DESCRIPTION OF THE DRAWING

Referring now to the drawings wherein like elements are numbered alike in the several Figures:

FIG. 1 illustrates a mixing portion of an injector;

FIG. 2 illustrates a cross-section of the mixing portion of an injector; and

FIG. 3 is a block diagram of a control system according to an embodiment of the invention.

### DETAILED DESCRIPTION OF THE INVENTION

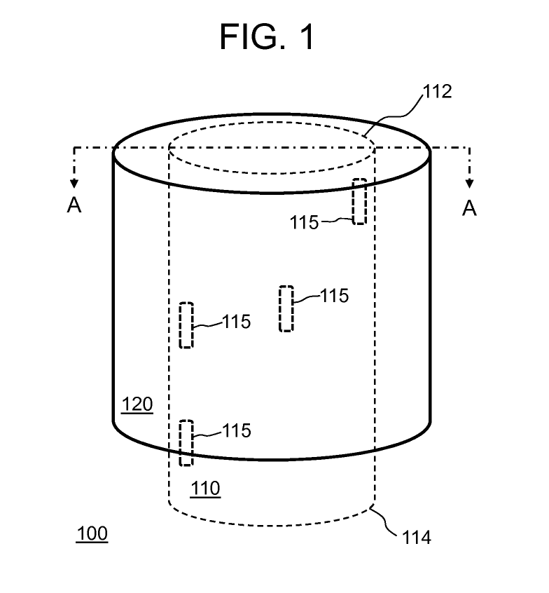

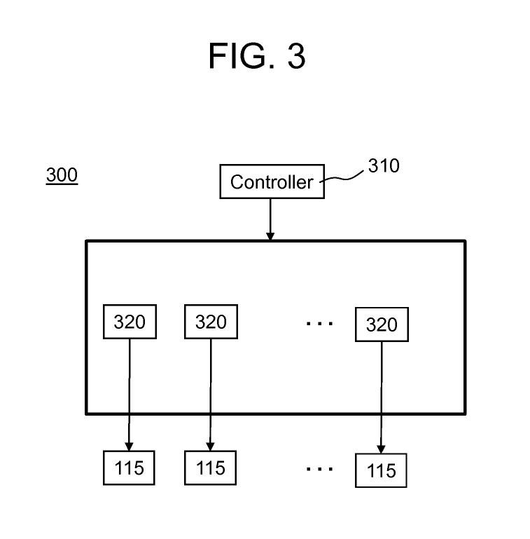

FIG. 1 illustrates a mixing portion 100 of an injector. As shown at FIG. 1, a center body 110 has an upper portion 112 and a lower portion 114 and is encircled by an outer body 120. Both the center body 110 and the outer body 120 are tube-like and are open at the upper portion 112 and the lower portion 114. The actuated areas 115 shown at FIG. 1 are exemplary indications of different areas of the center body 110 that may be moved by actuators. The actuators 320 (shown at FIG. 3) are not shown at FIG. 1 for clarity but may be, for example, wires attached to each of the actuated areas 115.

In one embodiment, the material of the center body 110 is a smart memory alloy (SMA) and each actuator 320 is an SMA actuator 320. In that case, the SMA actuators 320 may be wires carrying signals that cause movement at corresponding actuated areas 115. Each actuated area 115 of the center body 110 would be an area comprising a smart memory alloy that could be affected to move based on a control signal (from the actuator 320) in the form of a temperature change of the center body 110, for example. Based on a number and arrangement of the actuated areas 115, the shape of the center body 110 can be changed as needed to control an output from the center body 110 and, accordingly, the injector. In alternate embodiments, actuation modes that may be used to shape the center body 110 include Micro-Electro-Mechanical Systems (MEMS), Micro-Optical-Electro-Mechanical Systems (MOMS/MOEMS), and Piezoelectric sensors and actuators (PZT).

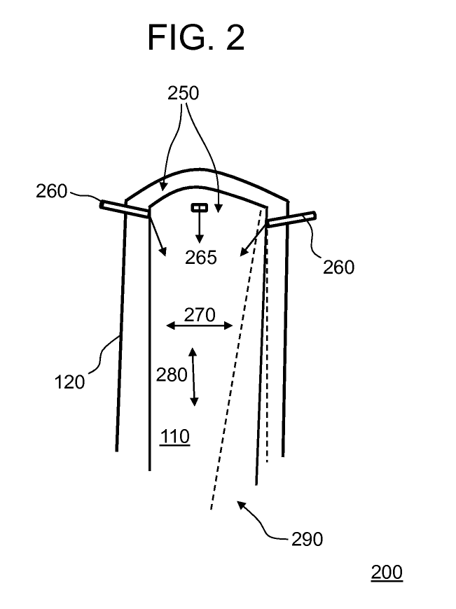

FIG. 2 illustrates a cross-section 200 of the mixing portion 100 of an injector at A-A. Air 250 is supplied into both the center body 110 and the space between the center body 110 and the outer body 120. The air 250 between the center body 110 and the outer body 120 helps to reduce wear on the outer body 120 caused by the heat generated by the combustor. Fuel 265 is injected through inlets 260 that pass through the outer body 120 and into the center body 110 near the upper portion 112. The air 250 in the center body 110 and the fuel 265 mix in the center body 110 and the mixture is output at the lower portion 114 of the center body 110.

By controlling the actuated areas 115 such as the exemplary actuated areas 115 shown at FIG. 1, the center body 110 may be subjected to horizontal flex 270 whereby the center body 110 is expanded from the inside out. In this case, there may be increased fuel 265 penetration into the mainstream (output from the lower portion 114 of the center body 110). Based on movement in the actuated areas 115, the center body 110 may instead experience elongation 280 whereby the center body 110 is tapered and lengthened as shown by 290. In this case, the direction of output of the fuel 265 and air 250 mixture at the lower portion 114 of the center body 110 may be controlled and, additionally, the mixing of fuel 265 with air 250 may be improved. Also, wear on the outer body 120 may be reduced when the center body 110 is elongated and tapered, because the gap between the center body 110 and outer body 120 is increased.

FIG. 3 is a block diagram of a control system 300. The control system 300 includes a controller 310 and a plurality of actuators 320. FIG. 3 shows each of the actuators 320 being associated with a corresponding actuated area 115 (shown at FIG. 1). However, an actuator 320 may control movement of more than one actuated area 115. The control of the actuators 320 by the controller 310 may be based on a number of parameters. For example, flow rate, cooling rate, velocity profile, and exit pressure may be among the parameters considered by the controller 310 in controlling the actuators 320. Generally, the controller 310 may comprise one or more processors and one or more memory devices and may operate based on predetermined or user input rules for controlling output of the center body 110. The controller 310 may operate on the actuators 320 of a single injector (an LLI injector, for example) or may control actuators 320 of a number of injectors. In alternate embodiments, the control may include radial expansion and contraction, tip expansion control, diaphragm control, pin actuated control, concentrically moving the cone, ball point tip control, and circumferential tapering volume control.

It will be recognized that the various components and technologies may provide certain necessary or beneficial functionality or features. Accordingly, these functions and features as may be needed in support of the appended claims and variations therefore, are recognized as being inherently included as a part of the teachings herein and a part of the invention disclosed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel injector control system, comprising:
a plurality of actuators, each actuator being configured to move one or more portions of a center body of the fuel injector; and
a controller configured to control each of the plurality of actuators individually to change a flow rate or a direction of output of a mixture of fuel and air from an outlet of the center body of the fuel injector.

2. The system according to claim 1, wherein the plurality of actuators are comprised of smart memory alloys (SMA).

3. The system according to claim 1, wherein the plurality of actuators are comprised of Micro-Electro-Mechanical Systems (MEMS), Micro-Optical-Electro-Mechanical Systems (MOMS/MOEMS), or Piezoelectric sensors and actuators (PZT).

4. The system according to claim 1, wherein the controller controls at least one of the plurality of actuators to expand the center body and increase a flow of fuel into the fuel injector.

5. The system according to claim 1, wherein the controller controls at least one of the plurality of actuators to elongate the center body and increase a mixture of fuel and air in the fuel injector.

6. The system according to claim 1, wherein the controller controls each of the plurality of actuators based on a desired flow rate, cooling rate, velocity profile, or exit pressure.

7. An adjustable fuel injector, comprising:
a center body having a tube-like shape with an opening at an upper portion and at a lower portion that is at an opposite end from the upper portion along a length of the center body, the center body configured to mix fuel and air, the fuel and the air being input at the upper portion, and to funnel a mixture of the fuel and the air through an outlet at the lower portion;
an outer body having a tube-like shape, the outer body encircling the center body and air being input between the outer body and the center body at the upper portion; and
a plurality of actuators controlled by a controller, each of the plurality of actuators being configured to move a different portion of the center body.

8. The fuel injector according to claim 7, wherein the fuel is injected substantially tangential to a length of the center body into the center body at the upper portion through a plurality of openings in the tube-like shape of the center body at the upper portion.

9. The fuel injector according to claim 7, wherein at least one of the plurality of actuators is controlled to change a shape of the outlet of the center body and thereby change a direction of the mixture of the fuel and the air through the outlet.

10. The fuel injector according to claim 7, wherein at least one of the plurality of actuators is controlled to change a flow rate of the mixture of the fuel and the air through the outlet by changing a slope of the center body from the upper portion to the lower portion.

11. The fuel injector according to claim 7, wherein the plurality of actuators are comprised of smart memory alloys (SMA).

12. The fuel injector according to claim 7, wherein the plurality of actuators are comprised of Micro-Electro-Mechanical Systems (MEMS), Micro-Optical-Electro-Mechanical Systems (MOMS/MOEMS), or Piezoelectric sensors and actuators (PZT).

13. The fuel injector according to claim 7, wherein at least one of the plurality of actuators is controlled to expand the center body out toward the outer body.

14. The fuel injector according to claim 7, wherein at least one of the plurality of actuators is controlled to elongate the center body and taper the outlet of the center body at the lower portion.

15. A method of controlling an injector, the method comprising:
arranging a plurality of actuators to move different parts of a center body of the injector; and
controlling movement of the plurality of actuators to change a size and a shape of an outlet of the center body of the injector.

16. The method according to claim 15, wherein the controlling includes controlling one or more of the plurality of actuators to expand the center body of the injector and to increase a flow rate of material from the outlet of the center body of the injector.

17. The method according to claim 15, wherein the controlling includes controlling one or more of the plurality of actuators to elongate the center body of the injector and to taper the outlet of the center body of the injector.

18. The method according to claim 15, wherein the controlling is based on a desired flow rate, cooling rate, velocity profile, or exit pressure.
